(19) United States
(12) Patent Application Publication
(10) Pub. No.: US 2020/0217131 A1
(43) Pub. Date: Jul. 9, 2020

(54) METHOD OF SCREENING A CAVITY WINDOW AND EXTERNAL AWNING FOR USE THEREWITH

(71) Applicant: Marc Lewis, Victoria (AU)

(72) Inventor: Marc Lewis, Victoria (AU)

(21) Appl. No.: 16/633,024

(22) PCT Filed: Oct. 30, 2017
(86) PCT No.: PCT/AU2017/051191

§ 371 Date: Jan. 22, 2020

(30) Foreign Application Priority Data
Jul. 26, 2017 (AU) 2017902934

(51) Int. Cl. E06B 9/60; E06B 9/66

(52) U.S. Cl. CPC E06B 9/60; E06B 9/78; E06B 9/66

(57) ABSTRACT

A method of covering a cavity window with an external awning, including the steps of: providing an awning, the awning having a flexible mesh screen and a spring loaded roller drum mounted along a bottom end thereof and around which the screen can be wound so that the awning can be selectively operated, the screen being sized to extend within the cavity in which the window is fitted and substantially across the width and height of the cavity; securing a mounting bracket to a lintel extending across an upper portion of the cavity, the bracket being disposed within the cavity and configured for securing an upper end of the awning within the cavity; securing an upper end of the awning to the bracket; and securing a lower end of the awning to a lower portion of the cavity to cover the window.

### FIELD OF THE INVENTION

The present invention relates to a method of screening a cavity window and an external awning for use in such a method. The awning is configured for use within the confines of an external window cavity of a dwelling, closely adjacent to a cavity window.

### BACKGROUND

Outdoor window awnings with a roller mechanism can be used outside of a window to block or protect a window from weather. In the summer months they can be used as a shade barrier from the direct sun heating up the window glass and preventing UV entering through the window glass. They also help against fading to indoor perishables. These awning types can also be used for privacy and to help prevent outsiders seeing past the awning and through to the window.

Generally, it is known that the most common cause of temperature gain inside a home in summer months is through any sun affected window. A barrier outside, rather than a barrier inside, is the most efficient way in stopping heat entering through a window. Such a barrier can stop the sun and UV at the first possible contact, preventing radiant glass occurring. Indoor blinds cannot stop sun heated radiant glass occurring.

Previous external window awnings, which typically extend outwardly from the window towards a lower end of the awning, can be bulky and expensive to make with many components. Also, previous external window awnings typically cannot be efficiently and easily installed and cannot be located close to the window, without leaving gaps around the sides. Minimal side gaps on the awning are needed to prevent sunlight passing through them to the window. Minimising side gaps allows for greater energy efficiency in cooling as there is more shading protection to the window. An awning allowing fewer gaps directly outside the window is best economically for an energy efficient household.

Minimising gaps around an awning also helps with privacy protection, allowing lesser of a gap for an outsider to see through.

Generally, previous outdoor window roller blinds are installed around the sides of a window cavity on the outside facing walls against a surface of the building and not within the cavity of the dwelling outside the window. These previous types of window awnings allow big gaps surrounding the window between the awning, wall and window. These gaps are caused by the awning positioning which is such as to allow for an unhindered operation to the window and blind. However, this allowance can affect the effectiveness of the blind as it allows extra sun and UV light through these gaps beyond to the window. Previous outside blind types can also be across a large wall area around a window to make sure minimal sunlight or UV light can enter beyond the gaps to the window glass. This type can make it unsightly, excessive and expensive.

Previous outside window blind designs can be either impossible to install within the cavity directly outside the windows dwelling, or if installed, can hinder operation of the window due to guide tracks commonly being used. This can also cause obstructions to the viewing capacity of the window when fitted.

Indoor window blinds can be installed within the internal cavity covering the inside window and can allow minimal or no obstruction to the operation of the window outside. However, indoor window blinds generally have poorer energy rating performance compared to any outside shade barrier as an outside window barrier firstly prevents raising temperatures inside from the sun contacting the window glass at the first point of contact.

Roller blinds having a lower mounted roller have long been proposed and are known from U.S. Pat. No. 692,455 and U.S. Pat. No. 862,644 to Kepler, U.S. Pat. No. 467,385 to Spencer, and more recently in WO20144085872 to the present applicant. Both Kepler and Spencer are directed to devices that fit to an external wall to screen a window and are suitable for windows that are generally flush with an external wall surface, but difficult to use with common cavity windows where the window is recessed inside the cavity and thus spaced from the window pane. If Kepler or Spencer were to be used to cover the entire cavity in which the window is fitted, a large gap between the screen and the window pane would result, thereby necessitating a large overlap of the sides of the screen over the cavity to prevent light passing onto the window pane. Furthermore, in Kepler for example, grooved drums 12 and 13 would contact the wall, displacing the bottom of the screen 10 and creating gaps through which light would pass. Similarly, the roller R of Spencer would displace the curtain C and create a gap through which light would pass.

WO20144085872 is directed to an outdoor blind for use as a café blind for closing in an outdoor area. This disclosure is not directed to an awning for screening sunlight. Also, this disclosure would suffer the same drawbacks as Kepler or Spencer in fitting the disclosed blind over the cavity of a cavity window in that a gap is left between the awning and the window pane.

The present invention seeks to address above described problems inherent with previous outdoor and indoor window type blinds or awnings, without the limitations effecting obstructions in privacy, sun and UV protection, energy efficiency, window functionality and the ascetics of a dwelling.

There is a need to address the above, and/or at least provide a useful alternative.

### SUMMARY

There is provided a method of covering a cavity window with an external awning, including the steps of:

providing an awning, the awning having a flexible mesh screen and a spring loaded roller drum mounted along a bottom end thereof and around which the screen can be wound so that the awning can be selectively operated, the screen being sized to extend within the cavity in which the window is fitted and substantially across the width and height of the cavity;

securing a mounting bracket to a lintel extending across an upper portion of the cavity, the bracket being configured for securing an upper end of the awning within the cavity;

securing an upper end of the awning to the bracket; and

securing a lower end of the awning to a lower portion of the cavity to cover the window.

According to a preferred embodiment, the awning includes a bar coupled to ends of the drum and extending generally parallel to the drum, whereby the awning is selectively operated by engaging the bar and raising and lowering the awning.

Preferably, the method further includes the step of securing at least one catch to a lower portion of the window cavity, the catch being configured to engage the bar to secure and tension the screen within the cavity. The at least one catch can be configured to allow movement of the awning away from the window.

Preferably, the mounting bracket has a channel formed therein and securing the upper end of the awning to the bracket includes inserting an upper end of the blind into the channel.

Preferably, the width of the screen exceeds the length of the drum so that ends of the screen overhang the drum, the cavity is a brick window cavity, and the mesh is a woven nylon and PVC mesh.

There is also provided an awning for use with a method of the above described type.

There is also provided an awning system for a cavity window, including an awning having a flexible mesh screen and a spring loaded roller drum mounted along a bottom end thereof and around which the screen can be wound so that the awning can be selectively operated, the screen being sized to extend within the cavity in which the window is fitted and substantially across the width and height of the cavity;

a mounting bracket configured to be secured to a lintel extending across an upper portion of the cavity, the bracket being configured for securing an upper end of the awning within the cavity;

at least one catch securable to a lower portion of the cavity to secure a lower end of the awning within the cavity.

In a preferred embodiment, the awning includes a bar coupled to ends of the drum and extending generally parallel to the drum, whereby the awning is selectively operated by engaging the bar and raising and lowering the awning.

Preferably, the at least one catch is configured to allow movement of the awning away from the window. The mounting bracket can have a channel formed therein, in which an upper end of the screen can be received.

Preferably, the width of the screen exceeds the length of the drum so that ends of the screen overhang the drum, and the mesh is a woven nylon and PVC mesh.

### BRIEF DESCRIPTION OF THE DRAWINGS

In order that the invention may be more easily understood, an embodiment will now be described, by way of example only, with reference to the accompanying drawings, in which:

FIG. 1: is a perspective view of an awning of one embodiment of the invention, the awning being in a condition in which a cavity window is covered;

FIG. 2: is a close perspective cutaway view of a lower portion of the awning;

FIG. 3: is a perspective view of the awning in a retracted condition;

FIG. 4: is a close perspective view of a bracket for mounting the awning, the bracket being fitted to a lintel within a cavity in which a window is mounted;

FIG. 5: is a side perspective view of a lower portion of the awning;

FIG. 6: is a front perspective view of a lower portion of the awning;

FIG. 7: is a perspective view of a bracket, two of which are used for mounting an engagement bar to a roller drum;

FIG. 8: is a perspective end view of a drum of the awning;

FIG. 9: are plan views of the awning in assembled and exploded conditions; and

FIG. 10: is an exploded view of an end of the awning.

### DETAILED DESCRIPTION

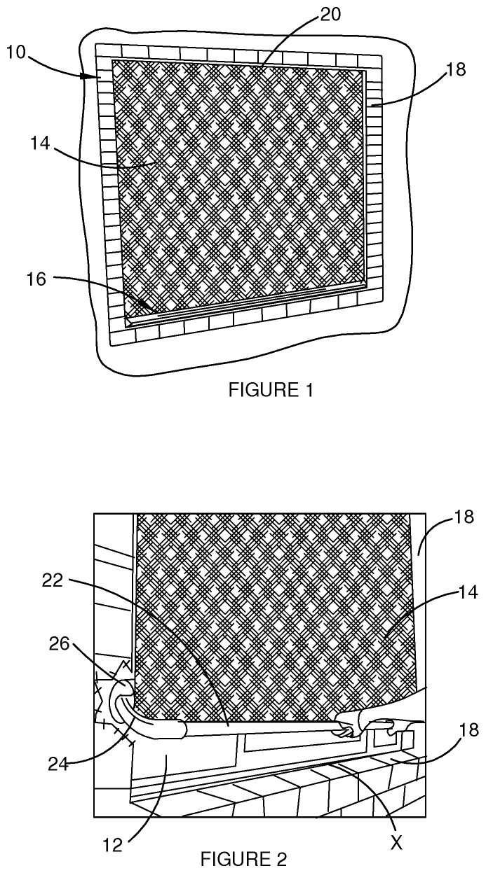

FIG. 1 illustrates an external awning 10. The external awning 10 is configured for

covering a cavity window 12. In particular, the awning 10 is configured to be received within the cavity 18 in which the window is fitted so as to lie closely adjacent to the window 12.

The awning 10 has a flexible mesh screen 14 and a spring loaded roller drum 16 mounted along a bottom end of the screen 14, and around which the screen 14 can be wound so that the awning 10 can be selectively operated by raising and lowering. The screen 14 is sized to extend within the cavity 18 in which the window is fitted and substantially across the width and height of the cavity 18.

The applicant has found that a bottom spring roller blind, such as that disclosed herein, is particularly useful in covering a cavity window as it can be adapted to be mounted within the cavity and very close to the window pane, thereby improving screening and reducing heating of the window.

Window coverings inside or outside can create privacy but can also block vision. Using an external mesh material can create a see-through view, in particular with the present invention where the amount of light passing around and behind the mesh is minimised and more accurately controlled. With prior awnings, having big awning gaps with a mesh material around the sides of material allows sunlight to reach behind the awning mesh sheet and allows the material to become more see through, which is undesirable.

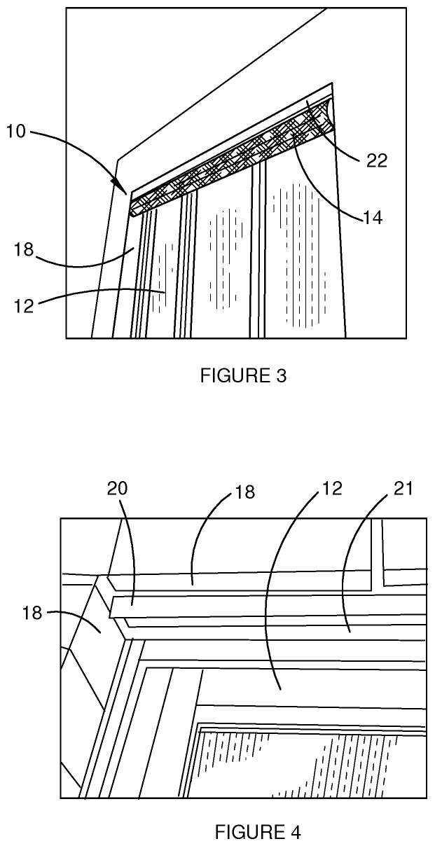

A mounting bracket 20 is secured to a lintel 21 (FIG. 4) extending across an upper portion of the cavity 18. The bracket 20 is configured for securing an upper end of the awning 10 within the cavity 18 and provides a clean appearance by covering an upper end of the awning. Preferably, bracket 20 is formed of a length of 90 degree extrusion and is of similar length to the window cavity and is fixed to the lintel with threaded fasteners. In one embodiment, the bracket 20 has a longitudinal track formed therein. In other embodiments, a separate track piece is provided which is securable to the bracket 20 and has a longitudinal track formed therein. In the longitudinal track, the upper end of the screen 14 is slid to secure the screen 14 to the window cavity 18.

A lower portion of the awning 10 is configured to be secured within the cavity 18 to cover the window 12. In this regard, at least one catch (not shown) may be provided within a lower portion of the cavity 12. In one embodiment, a single catch is provided at location X, as shown in FIG. 2, the catch being configured to engage bar 22 of the awning 10 and keep the awning 10 in the lowered condition. The or each catch can be of a hook type, or clips or other similar locking mechanisms can be used. It should be noted that when the awning is in a locked down position, i.e. the lower edge is secured, the screen 14 does not protrude past the external cavity 18 of a dwelling. Installing the screen 14 close to the window and within the cavity allows only a minimal amount of light to enter behind the screen, thereby creating a darker space between the screen and window. Having a darker space behind a screen will make it difficult to see through from the lighter opposite side of the screen, effectively creating a one way see through barrier in which someone behind the window can look out when awning is fully down but preventing outsiders looking in through into the window and beyond.

The catch can be formed with slide out rails for the awning 10 to move beyond the cavity 18 when a certain window type operation is needed. When the roller mechanism 16 is in the full retracted mode at the top of cavity 18 it is able to sit up in this position with the spring tension or can be assisted with hooks or locking points (not shown) on the handle 22 of the roller mechanism 16 on the awning 10.

It has previously been counterintuitive to use a bottom screen roller blind/screen within a cavity window for the above discussed reasons. However, the applicant has observed that by providing a bottom spring roller awning of a size corresponding to a cavity in which a cavity window is installed, and mounting it within the cavity, as described herein, the window can be almost entirely covered and to a much a higher degree that was previously possible with previous external awnings that are spaced from the window. In this regard, as the screen can be fitted close to the window pane, an overlap between the window frame and the screen can be achieved, reducing the amount of light that can pass around the awning and through the window and thereby reducing heating of the window. In addition, the use of a bottom spring roller blind provides a simple and easy to operate awning that can be manufactured cost effectively.

Furthermore, as the screen 14 is close to the window pane and the amount of light passing through or around the screen 14 is minimised, privacy is improved as it is difficult to see through the screen 14. Also, as the awning 10 is received within the cavity, it can be less vulnerable to accidental contact damage and less exposed to wind.

The mesh screen 14 is a blend of nylon for strength and UV rated PVC coated to act as weather protection to the nylon. The screen 14 may be woven. The screen 14 allows the awning 10 to provide shade protection as well as allowing vision from within the room being screened. Preferably, the screen 14 has a see-through factor range or openness range of 20% to 1%

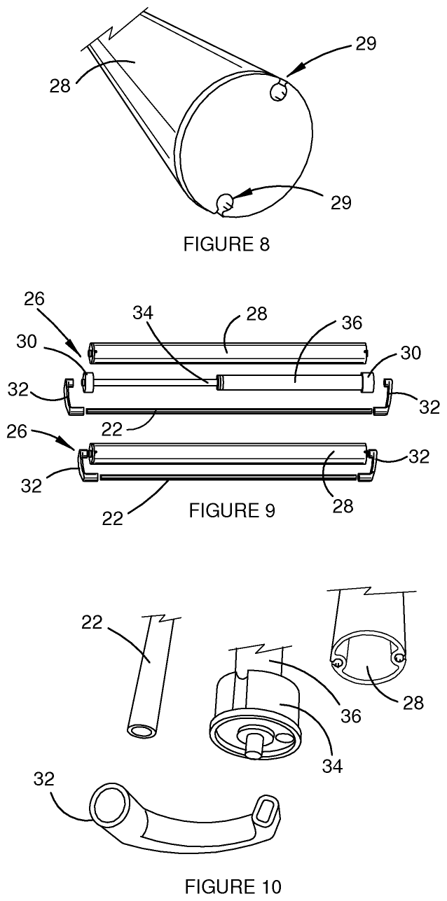

The mesh screen 14 is edged along top and bottom edges to provided parallel edged ends and to increase strength so that the screen 14 can be mounted at the top edge and support a drum along a bottom edge. A longitudinal groove 29 is formed along a cylindrical drum 28 (see FIG. 8) of the spring loaded roller drum 16 for attachment of the bottom edge of the screen 16, which slides into the longitudinal groove 29.

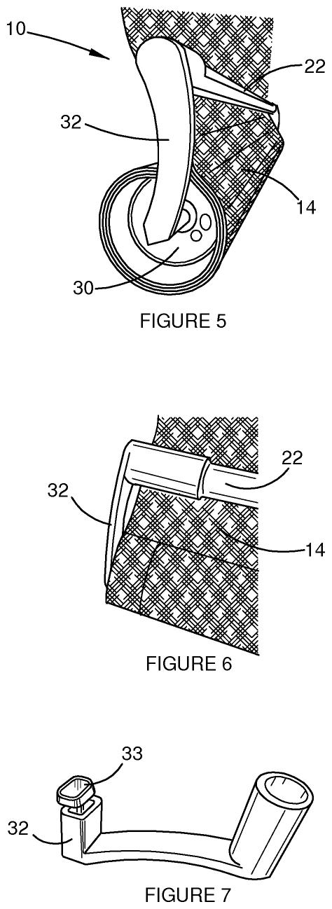

As illustrated in FIG. 5, the drum 28 in longitudinal length is shorter than the width of the screen 14 to provide overhang of the screen 14 over the drum 28. In this regard, the screen 14 overhang extends past both opposing drum assembly closed ends 30 and through to the coupled end brackets 32, but not beyond the end brackets. In use, i.e. when installed on a dwelling, this configuration disperses the weight of the roller mechanism 16 along to the centre of the screen 14 and away from the edges, which can be vulnerable to damage and/or wear. Such a configuration minimises stretch damage on both side edges and can reduce the manufacturing cost of the awning 10 as side edges do not require protective finishes. An equal overhang at both ends is preferred.

The screen 14 in its preferred position on the drum assembly 26 is wound and wrapped around the drum assembly 26 of the roller mechanism. The screen 14 preferably has an extra allowance length included which is more than the proposed installation length/height of the cavity 18. A preferred extra allowance length of two drum rotations is preferably included to clamp the screen 14 against the drum assembly 26 and stop longitudinal movement, in turn containing the sides of the spring loaded roller drum 16 from touching the side walls of the cavity 18 when installed, in operation or lock down mode whereby the spring loaded roller drum is secured with the catch.

The extra wrapping allowance also ensures that the drum 28 is covered when fully extended, thereby providing an aesthetically pleasing appearance. The side overhang of the screen 14 also hides the joining point of brackets 32 to the drum 28 and provides weather protection of the drum 28. As illustrated in FIG. 7, an end portion 33 of bracket 32 may be provided with a

With reference to FIGS. 5 to 10, the spring loaded roller drum 16 is shown in more detail. The spring loaded roller drum 16 includes a handle bar 22, end brackets 24 and the drum assembly 26. The drum assembly 26 includes a hollow cylindrical drum 28 with a longitudinal groove formed along the drum 28. The cylindrical drum 28 has a cap with a centred idler 34 at one opposing end 30 and an internal torsion spring 36 fixed to the other opposing end 30, in turn making the drum ends 30 closed at both ends of the drum assembly 26. The described drum assembly 26 is coupled with the end brackets 32 and handle bar 22 for a completed self-contained roller mechanism 16.

Once attached, the awning 10 is tensioned with the roller mechanism spring 36. The tensioned roller mechanism 16 is parallel to the attached track top edge in turn providing a constant retraction mode towards the top lintel within the external cavity of a dwelling. The awning can be operated to the down position using the handle bar 22 on the roller mechanism 16. The handle bar 22 can also act as a break if tensioned to do this as it pushes against the screen 14 from the torsion spring load.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A method of covering a cavity window with an external awning, including the steps of:
providing an awning, the awning having a flexible mesh screen and a spring loaded roller drum mounted along a bottom end thereof and around which the screen can be wound so that the awning can be selectively operated, the screen being sized to extend within the cavity in which the window is fitted and substantially across the width and height of the cavity;
securing a mounting bracket to a lintel extending across an upper portion of the cavity, the bracket being disposed within the cavity and configured for securing an upper end of the awning within the cavity;
securing an upper end of the awning to the bracket; and
securing a lower end of the awning to a lower portion of the cavity to cover the window.

2. A method according to claim 1, wherein the awning includes a bar coupled to ends of the drum and extending generally parallel to the drum, whereby the awning is selectively operated by engaging the bar and raising and lowering the awning.

3. A method according to claim 2, wherein the method further includes the step of securing at least one catch to a lower portion of the window cavity, the catch being configured to engage the bar to secure and tension the screen within the cavity.

4. A method according to claim 3, wherein the at least one catch is configured to allow movement of the awning away from the window.

5. A method according to claim 1, wherein the mounting bracket has a channel formed therein and securing the upper end of the awning to the bracket includes inserting an upper end of the blind into the channel.

6. A method according to claim 1, wherein the width of the screen exceeds the length of the drum so that ends of the screen overhang the drum.

7. (canceled)

8. A method according to claim 1, wherein the mesh is a woven nylon and PVC mesh.

9. An awning for use with a method according to claim 1.

10. An awning system for a cavity window, including an awning having a flexible mesh screen and a spring loaded roller drum mounted along a bottom end thereof and around which the screen can be wound so that the awning can be selectively operated, the screen being sized to extend within the cavity in which the window is fitted and substantially across the width and height of the cavity;
a mounting bracket configured to be secured to a lintel extending across an upper portion of the cavity, the bracket being configured for securing an upper end of the awning within the cavity;
at least one catch securable to a lower portion of the cavity to secure a lower end of the awning within the cavity.

11. A system according to claim 10, wherein the awning includes a bar coupled to ends of the drum and extending generally parallel to the drum, whereby the awning is selectively operated by engaging the bar and raising and lowering the awning.

12. A system according to claim 10, wherein the at least one catch is configured to allow movement of the awning away from the window.

13. A system according to claim 10, wherein the mounting bracket has a channel formed therein, in which an upper end of the screen can be received.

14. A system according to claim 10, wherein the mounting bracket is configured to position the screen from the window.

15. A system according to claim 10, wherein the width of the screen exceeds the length of the drum so that ends of the screen overhang the drum.

16. A system according to claim 10 wherein the mesh is a woven nylon and PVC mesh.
